(19) United States
(12) Patent Application Publication
(10) Pub. No.: US 2014/0328402 A1
(43) Pub. Date: Nov. 6, 2014

(54) EFFICIENT INITIALIZATION OF A REFERENCE FRAME OF A BI-PREDICTED/PREDICTED VIDEO FRAME DURING DECODING THEREOF

(71) Applicant: NVIDIA Corporation, Santa Clara, CA (US)

(72) Inventors: Shashank Garg, Pune (IN); Soumenkumar Dey, Pune (IN)

(73) Assignee: NVIDIA Corporation, Santa Clara, CA (US)

(21) Appl. No.: 13/887,389

(22) Filed: May 6, 2013

(51) Int. Cl. H04N 19/89; H04N 19/577

(52) U.S. Cl. CPC H04N 19/00939; H04N 19/00721
USPC 375/240.15

(57) ABSTRACT

A method includes determining, through a decoder engine executing on a processor communicatively coupled to a memory and/or a hardware decoder, that a reference video frame of a bi-predicted frame or a predicted frame currently being decoded is unavailable or corrupt. The method also includes initializing, through the decoder engine and/or the hardware decoder, a previously initialized another reference video frame of the bi-predicted frame or the predicted frame as the reference video frame instead of the unavailable or the corrupt reference video frame to enable prediction of the bi-predicted frame or the predicted frame with reduced distortion.

### FIELD OF TECHNOLOGY

This disclosure relates generally to video decoding and, more particularly, to a method, a device and/or a system of efficient initialization of a reference frame of a bi-predicted/predicted video frame during decoding thereof.

### BACKGROUND

Decoding of a bi-predicted video frame (e.g., B-frame) may require forward and/or backward reference frames. A forward reference frame may be in a temporal past compared to the bi-predicted video frame and a backward reference frame may be in a temporal future compared to the bi-predicted video frame. In the case of the forward/backward reference frames being unavailable (e.g., during a seek event on a user interface of a multimedia application rendering video data), a decoder performing the decoding may ignore the forward/backward reference frames or may skip the decoding of the bi-predicted video frame. A scheme incorporating such a decoding technique may lead to corruption in the decoded video data. Further, the technique of skipping decoding of the bi-predicted video frame may prove to be restrictive in scenarios where the bi-predicted frame solely requires forward reference frames for prediction thereof.

### SUMMARY

Disclosed are a method, a device and/or a system of efficient initialization of a reference frame of a bi-predicted/predicted video frame during decoding thereof.

In one aspect, a method includes determining, through a decoder engine executing on a processor communicatively coupled to a memory and/or a hardware decoder, that a reference video frame of a bi-predicted frame or a predicted frame currently being decoded is unavailable or corrupt. The method also includes initializing, through the decoder engine and/or the hardware decoder, a previously initialized another reference video frame of the bi-predicted frame or the predicted frame as the reference video frame instead of the unavailable or the corrupt reference video frame to enable prediction of the bi-predicted frame or the predicted frame with reduced distortion.

In another aspect, a data processing device includes a memory, and a processor communicatively coupled to the memory. The processor is configured to execute instructions to determine that a reference video frame of a bi-predicted frame or a predicted frame currently being decoded therethrough is unavailable or corrupt. Further, the processor is configured to execute instructions to initialize a previously initialized another reference video frame of the bi-predicted frame or the predicted frame as the reference video frame instead of the unavailable or the corrupt reference video frame to enable prediction of the bi-predicted frame or the predicted frame with reduced distortion.

In yet another aspect, a system includes a source data processing device configured to encode video data including data associated with a bi-predicted frame or a predicted frame as a video sequence, and a decoder communicatively coupled to the source data processing device. The decoder is a hardware decoder and/or a decoder engine executing on a processor communicatively coupled to a memory. The decoder is configured to determine that a reference video frame of the bi-predicted frame or the predicted frame currently being decoded therethrough is unavailable or corrupt. Further, the decoder is configured to initialize a previously initialized another reference video frame of the bi-predicted frame or the predicted frame as the reference video frame instead of the unavailable or the corrupt reference video frame to enable prediction of the bi-predicted frame or the predicted frame with reduced distortion.

The methods and systems disclosed herein may be implemented in any means for achieving various aspects, and may be executed in a form of a non-transitory machine-readable medium embodying a set of instructions that, when executed by a machine, cause the machine to perform any of the operations disclosed herein.

Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a schematic view of a video system, according to one or more embodiments.

FIG. 2 is a schematic view of a multimedia framework implemented in a client device of the video system of FIG. 1, according to one or more embodiments.

FIG. 3 is a schematic view of video data encoded in the video system of FIG. 1 with a key frame followed by a predicted frame or a bi-predicted frame.

FIG. 4 is a flowchart detailing the operations involved in efficient initializations of missing (or, corrupt) reference frames of a bi-predicted frame being decoded through the video system of FIG. 1, according to one or more embodiments

FIG. 5 is a process flow diagram detailing the operations involved in efficient initialization of a reference frame of a bi-predicted/predicted video frame during decoding thereof through the video system of FIG. 1, according to one or more embodiments.

Other features of the present embodiments will be apparent from the accompanying drawings and from the detailed description that follows.

### DETAILED DESCRIPTION

Example embodiments, as described below, may be used to provide a method, a device and/or a system of efficient initialization of a reference frame of a bi-predicted/predicted video frame during decoding thereof. Although the present embodiments have been described with reference to specific example embodiments, it will be evident that various modifications and changes may be made to these embodiments without departing from the broader spirit and scope of the various embodiments.

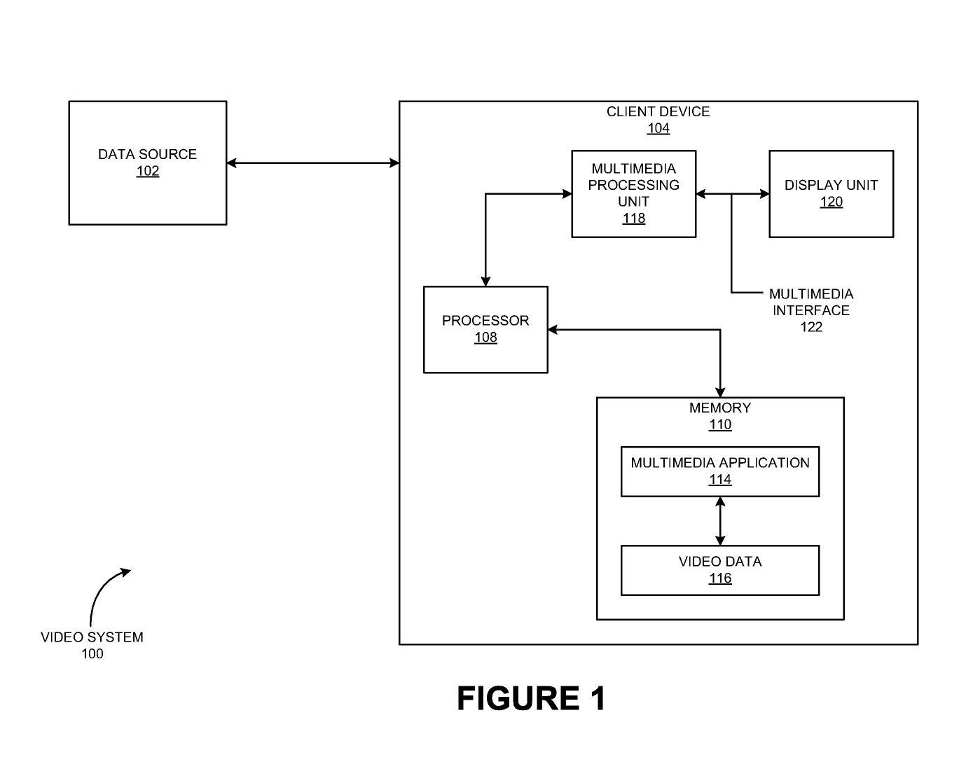

FIG. 1 shows a video system 100, according to one or more embodiments. In one or more embodiments, video system 100 may include a data source 102 communicatively coupled to a client device 104 (e.g., through a computer network such as Internet, a Local Area Network (LAN) and a Wide Area Network (WAN), or, through a direct coupling). It should be noted that data source 102 and client device 104 may be the same data processing device (e.g., a desktop computer, a laptop computer, a notebook computer, a netbook or a mobile device such as a mobile phone). In one or more embodiments, data source 102 may be a server configured to encode a video sequence as video data and transmit the video data to client device 104.

In typical solutions, a video frame may be received at client device 104, following which a decoder thereat decodes the video frame. Any video frame successfully decoded may become one of the reference frames to be utilized in decoding succeeding video frames of the video data. The reference frames may be classified into two categories, viz. forward and backward. A forward reference frame may be a video frame in a temporal past compared to a current video frame being decoded, and a backward reference frame may be a video frame in a temporal future compared to the current video frame being decoded. As the backward reference frame may also be utilized as a reference frame, the backward reference frame is encoded before the current video frame during the encoding process.

Sub-partitions (e.g., macroblocks) of the current frame being decoded may refer to the forward reference frame, the backward reference frame or both for temporal reconstruction information. Depending upon the video standard utilized to encode the video sequence, it is possible that there may be one or more forward reference frames and one or more backward reference frames. Such frames requiring both forward and backward reference frames to be predicted may be called bi-directional predicted (bi-predicted) frames (B-frames). Normally, a B-frame prediction requires both forward and backward reference frame(s), but it may also be possible that all macroblocks of a B-frame solely refer to forward reference frame(s).

The scenario of all the macroblocks of the B-frame solely pointing/referring to forward reference frame(s) may result in the B-frame being correctly decoded even if the backward reference frame(s) are not initialized. Initialization may include programming pointers (e.g., through a processor of client device 104) to enable reading of data associated with one or more forward reference frame(s) and/or one or more backward reference frame(s) from one or more memory address locations in a memory of client device 104 and to enable writing of data associated with the current frame being decoded to an appropriate memory address (e.g., in the memory of client device 104).

Now, if the B-frame discussed above requires missing backward reference frame(s) for temporal prediction of some or all of macroblock(s) thereof, an invalid/corrupted video stream may result therefrom, which may require playback of the video data to be stopped and/or error concealment to be done. Performance of the decoding may be hampered, for example, because of the requirement of scanning for each macroblock in software before the handing over thereof to hardware to be decoded. If the B-frame is rejected based on the fact that backward reference frame(s) thereof are not available, the decoding of temporally succeeding frames may result in large magnitude(s) of error(s)/distortion when none of the macroblocks of one or more of the temporally succeeding frames require backward reference frame(s) for prediction thereof.

Referring back to FIG. 1, client device 104 may include a processor 108 communicatively coupled to a memory 110. In one or more embodiments, processor 108 may be a Central Processing Unit (CPU), a Graphics Processing Unit (GPU) and/or any dedicated processor configured to execute an appropriate decoding engine thereon (decoding engine may instead be hardware); the dedicated processor may, alternately, be configured to control the appropriate decoding engine executing on another processor. All variations therein are within the scope of the exemplary embodiments. In one or more embodiments, memory 110 may be a volatile memory and/or a non-volatile memory.

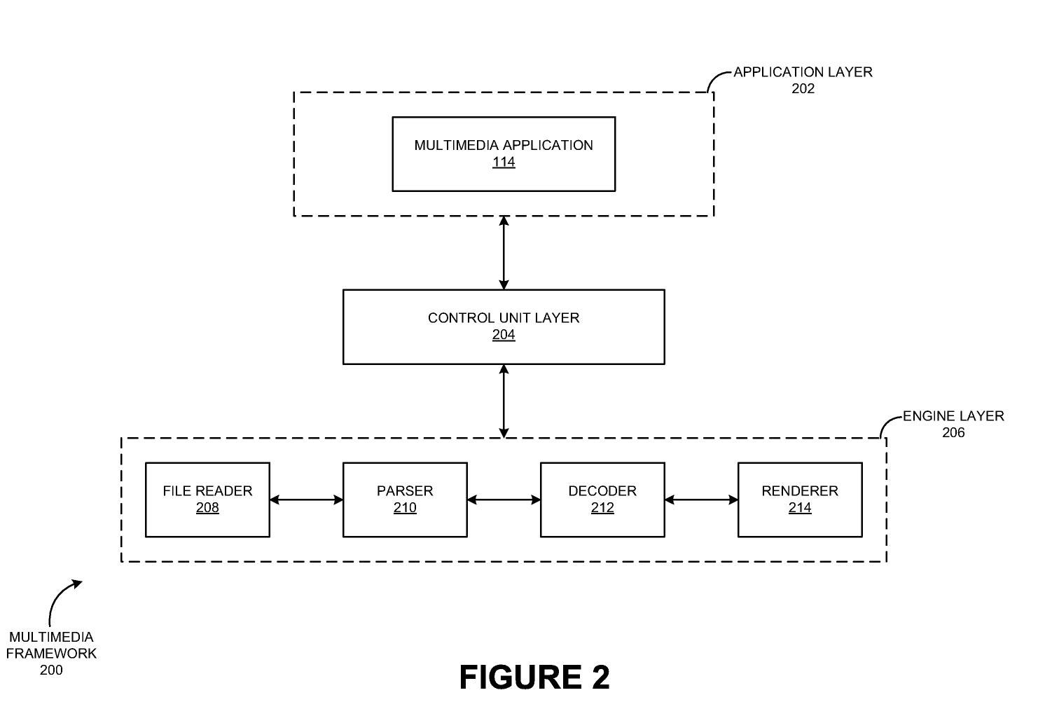

In one or more embodiments, client device 104 may execute a multimedia application 114 on processor 108; multimedia application 114 may be configured to render video data as a stream on an interface thereon. FIG. 1 shows multimedia application 114 as being stored in memory 110 to be executed on processor 108. FIG. 1 also shows video data 116 to be rendered through multimedia application 114 as also being resident in memory 110 (e.g., volatile memory). In one or more embodiments, multimedia application 114 may utilize an Application Programming Interface (API) of a multimedia framework (to be discussed with regard to FIG. 2) in order to execute processing associated therewith.

In one or more embodiments, output data associated with processing through processor 108 may be input to a multimedia processing unit 118 configured to perform encoding/decoding associated with the data. In one or more embodiments, the output of multimedia processing unit 118 may be rendered on a display unit 120 (e.g., Liquid Crystal Display (LCD) display, Cathode Ray Tube (CRT) monitor) through a multimedia interface 122 configured to convert data to an appropriate format required by display unit 120.

FIG. 2 shows a multimedia framework 200 implemented in client device 104, according to one or more embodiments. In one or more embodiments, multimedia framework 200 may provide multimedia capture, processing and/or playback facilities utilizing local or remote sources. In one or more embodiments, multimedia framework 200 may be above a foundation layer that facilities access of hardware such as a soundcard/display. In one or more embodiments, multimedia framework 200 may include an application layer 202 configured to communicate with a control unit layer 204 to enable performing a task required by multimedia application 114. Thus, multimedia application 114 may be at a level of application layer 202. In one or more embodiments, control unit layer 204 may control dataflow through engines (or, modules; shown as part of engine layer 206) of multimedia framework 200 such as file reader 208, parser 210, decoder 212 (e.g., hardware engine or software engine) and renderer 214.

File reader 208 may be configured to enable reading of video data 116. Parser 210 (e.g., Moving Picture Experts Group (MPEG) parser, Audio-Video Interleave (AVI) parser, H.264 parser) may parse video data 116 into constituent parts thereof. Decoder 212 may decode a compressed or an encoded version of video data 116 and renderer 214 may transmit the decoded data to a destination (e.g., a rendering device). The rendering process may also include processes such as displaying multimedia on display unit 120, playing an audio file on a soundcard, writing the data to a file etc. It is obvious that the aforementioned engines (or, modules) are merely shown for illustrative purposes and that variations therein are within the scope of the exemplary embodiments.

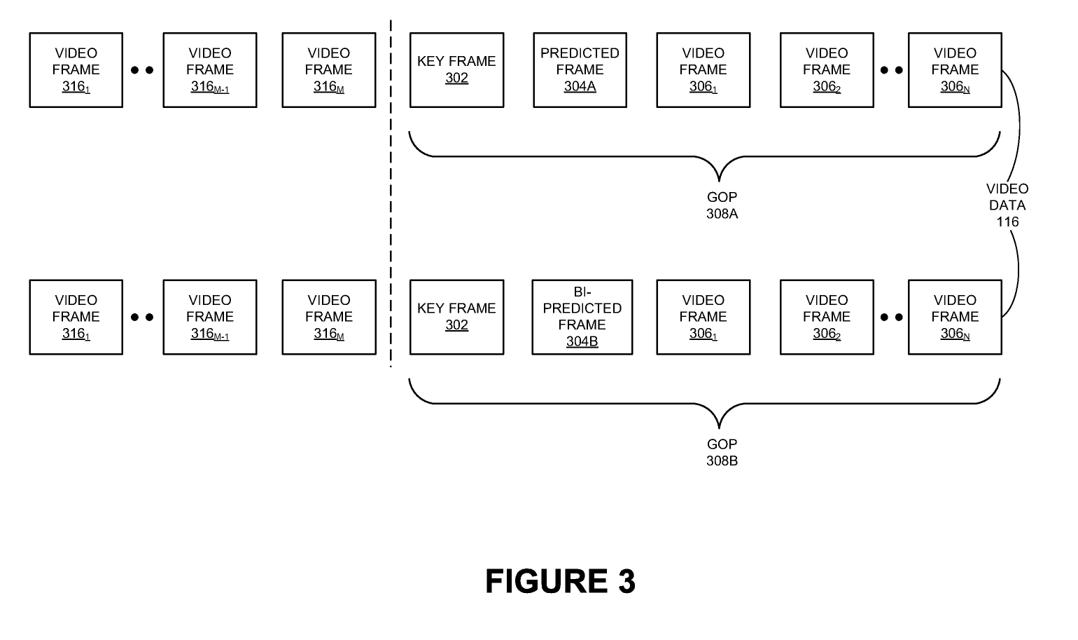

Further, it is obvious that multimedia framework 200 is merely shown for illustrative purposes, and that exemplary embodiments are not limited to implementations involving multimedia framework 200. FIG. 3 shows video data 116 being encoded with a key frame 302 (e.g., an intra-frame), followed by a predicted frame (e.g., predicted frame 304A) or a bi-predicted frame (e.g. bi-predicted frame 304B). Video data 116 may include a Group of Pictures (GOP) (e.g., GOP 308A or GOP 308B), which begins with key frame 302. All constituent macroblocks of key frame 302 may be required to be decoded through decoder 212. In one or more embodiments, video data 116 may be encoded with a plurality of key frames across a temporal duration thereof. A GOP may be an open GOP or a closed GOP. An open GOP may allow for video frames thereof to reference data from video frame(s) of a previous GOP. A closed GOP may not include a bi-predicted frame immediately following key frame 302; alternately, even if the bi-predicted frame immediately follows key frame 302, the aforementioned bi-predicted frame may not include reference data from the previous GOP.

In FIG. 3, GOP 308A may be formed by key frame 302, predicted frame 304A and other video frames 306_{1-N}, and GOP 308B may be formed by key frame 302, bi-predicted frame 304B and other video frames 306_{1-N}. FIG. 3 also shows frames of a previous GOP, viz. video frames 316_{1-M}. Now, if a current video frame being decoded is bi-predicted frame 304B, the aforementioned bi-predicted frame 304B may require both one or more forward reference frame(s) and one or more backward reference frame(s) for correct decoding/prediction thereof. Alternately, bi-predicted frame 304B may merely require the one or more forward reference frame(s) OR the one or more backward reference frame(s) for the correct decoding/prediction thereof. To determine the existence of one of the aforementioned two cases, decoder 212 may have to parse through the entire bi-predicted frame 304B, which is performance-hampering. Now, in the case of bi-predicted frame 304B requiring both forward and backward reference frame(s) for prediction thereof, a missing reference frame may result in corruption during rendering of decoded video data 116. If decoder 212 is made to be over-restrictive to prevent the aforementioned corruption by skipping decoding of bi-predicted frame 304B, the other case of bi-predicted frame 304B merely requiring forward OR backward reference frame(s) during decoding is unnecessarily prohibited.

Thus, in one or more embodiments, if a backward reference frame (e.g., say, video frame 316₅) for a current video frame (e.g., say, a B-frame, viz. video frame 316₄ is being decoded) being decoded is unavailable (or, data associated therewith is corrupt; the unavailability may be due to an unforeseen event such as a seek bar movement on a user interface of multimedia application 114), decoder 212 may initialize a forward reference frame (or, a reference frame marked as forward; say, video frame 316₂) thereof in place of the missing backward reference frame as the backward reference frame. In one or more embodiments, in the case of a bi-predicted frame (e.g., video frame 306₁) requiring multiple forward and backward reference frames (e.g., in the case of H.264 video standard), then a forward reference frame (e.g., predicted frame 304A) after a key frame (e.g., key frame 302) is initialized as the reference frame instead of all missing (or, corrupt) forward reference frames and backward reference frames. In one or more embodiments, once a reference frame is marked as a backward reference frame, the aforementioned backward reference frame initializations may be replaced with the reference frame marked as the backward reference frame.

Now, in one or more embodiments, all temporally succeeding reference frames may be appropriately marked in accordance with the appropriate determination through decoder 212 till the next key frame. In one or embodiments, the abovementioned process may then be required to be repeated.

Thus, in one or more embodiments, a simple innovative initialization of the reference frames may deal with the problems discussed above without hampering performance. Assume that a bi-predicted frame (e.g., video frame 316_{M}) is immediately followed by an intra-frame (e.g., an I-frame or an IDR frame in the case of the H.264 video standard; say key frame 302 here) either due to the encoding of video data 116 or corruption. If all macroblocks of video frame 316_{M} are solely pointing to forward reference frames (e.g., any one or more of video frame(s) 316_{1-(M-1)}), video frame 316_{M} may be decoded correctly. If some macroblocks of video frame 316_{M} point to one or more backward reference frame(s) (say, predicted frame 304A and/or one or more of video frames 306_{1-N}) that denote an invalid/corrupted video stream, said macroblocks may be automatically concealed by data from a logically suitable reference frame (e.g., the same forward reference frame initialized as the missing backward reference frame discussed above).

In scenarios such as a user of client device 104 seeking to a desired point in time of video data 116 on multimedia application 114 through a user interface thereof, not all multimedia applications (e.g., a flash video player example of multimedia application 114) may differentiate between, for example, an H.264 semantic such as an I-frame with closed/open GOP and an IDR frame. All occurrences of the I-frame may be treated as a key frame. Doing this may be catastrophic to the decoded video quality because in accordance with the seek action, all reference frames may be initialized back to NULL in decoder 212. However, for the B-frames following the I-frame with the open GOP (e.g., bi-predicted frame 304B), the reference frames may be essential for decoding thereof. Exemplary embodiments provide for a means to initialize said reference frames to previously initialized reference frames instead of NULL values.

It should be noted that an initialized reference frame temporally closest to the missing reference frame of the current video frame being decoded may be chosen for initialization as the missing (or, corrupt) reference frame. Moreover, any one or more initialized references frames may be chosen for initialization as the one or more missing (or, corrupt) reference frames of the current video frame being decoded.

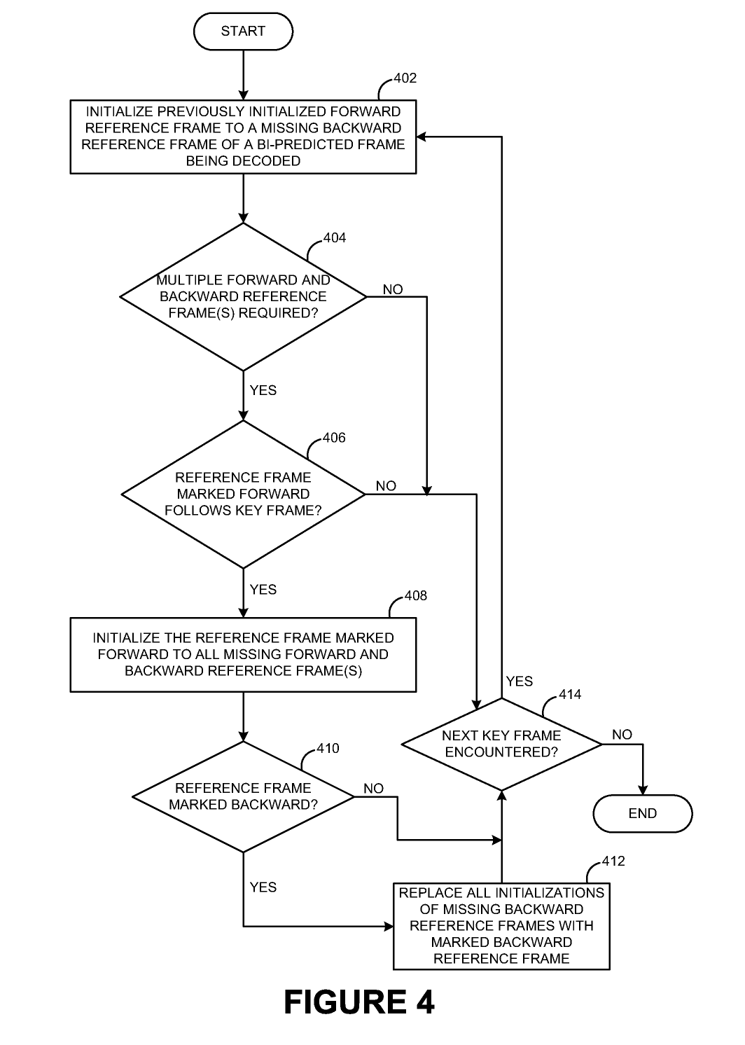

FIG. 4 shows a flowchart summarizing the initialization process discussed above, according to one or more embodiments. In one or more embodiments, operation 402 may involve initializing, through decoder 212, a previously initialized forward reference frame to a missing (or, corrupt) backward reference frame of a bi-predicted frame being decoded. In one or more embodiments, operation 404 may involve checking (e.g., through decoder 212) as to whether the bi-predicted frame requires multiple forward and backward reference frames. In one or more embodiments, if yes, operation 406 may involve checking as to whether a reference frame of the bi-predicted frame marked forward temporally follows a key frame. In one or more embodiments, if yes, operation 408 may involve initializing the reference frame marked forward to all missing (or, corrupt) forward reference frames and backward reference frames. In one or more embodiments, operation 410 may involve checking as to whether a reference frame of the bi-predicted frame is marked backward. In one or more embodiments, if yes, operation 412 may involve replacing all initializations of missing backward reference frames with the marked backward reference frame. In one or more embodiments, operation 414 may involve checking as to whether a next key frame is encountered. In one or more embodiments, if yes, control may transfer to operation 402.

Thus, decoding of the bi-predicted frame may be efficiently performed based on the initializations summarized in FIG. 4. It should be noted that instructions associated with the initialization may be provided in a driver component (e.g., a set of instructions) associated with processor 108. Said driver component may be packaged with multimedia application 114 and/or packaged with an operating system executing on client device 104. Further, instructions associated with the driver component may be tangibly embodied on a non-transitory medium (e.g., a Compact Disc (CD), a Digital Video Disc (DVD), a Blu-ray disc®, a hard drive; appropriate instructions may be downloaded to the hard drive) readable through client device 104. All variations are within the scope of the exemplary embodiments discussed herein.

Last but not the least, it should be noted that the initialization scheme discussed above with respect to bi-predicted frames may also be applicable to predicted frames (P-frames) with multiple reference frames in a temporal past thereto (e.g., in the case of H.264 video standard). When the video standard is H.264 and video data 116 includes an open GOP, a seek action performed through the user interface of multimedia application 114 may refer to an I-frame that is a non-IDR frame. Here, in one or more embodiments, a predicted frame (P-frame) may utilize frames in a temporal past relative to the non-IDR I-frame for prediction thereof. In one or more embodiments, the non-IDR I-frame may be initialized as one or more reference frame(s) of the P-frame instead of unavailable/corrupt reference frame(s) thereof.

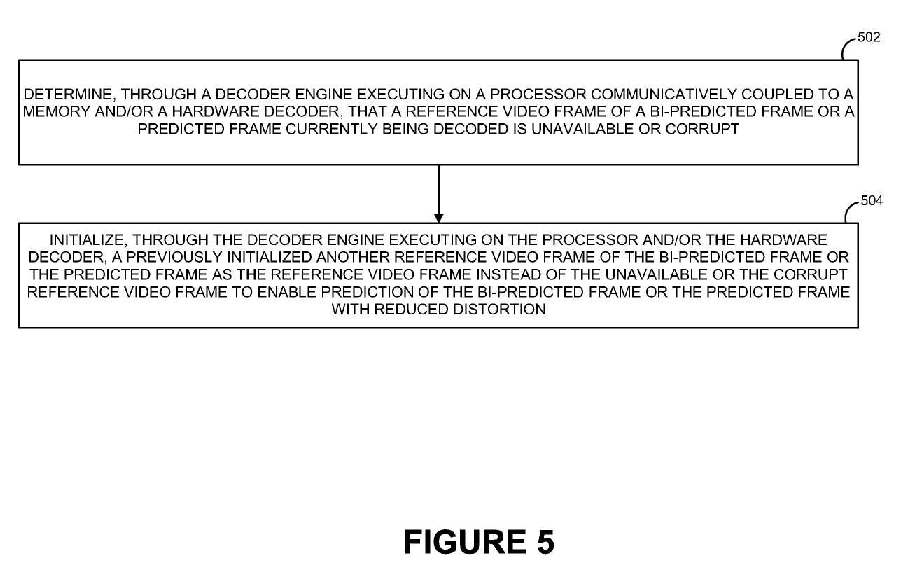

FIG. 5 shows a process flow diagram detailing the operations involved in efficient initialization of a reference frame of a bi-predicted/predicted video frame during decoding thereof, according to one or more embodiments. In one or more embodiments, operation 502 may involve determining, through a decoder engine (e.g., decoder 212) executing on processor 108 of client device 104 communicatively coupled to memory 110 and/or a hardware decoder, that a reference video frame of the bi-predicted frame or the predicted frame currently being decoded is unavailable or corrupt. In one or more embodiments, operation 504 may then involve initializing, through the decoder engine and/or the hardware decoder, a previously initialized another reference video frame of the bi-predicted frame or the predicted frame as the reference video frame instead of the unavailable or the corrupt reference video frame to enable prediction of the bi-predicted frame or the predicted frame with reduced distortion.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry (e.g., CMOS based logic circuitry), firmware, software or any combination of hardware, firmware, and software (e.g., embodied in a non-transitory machine-readable medium). For example, the various electrical structure and methods may be embodied using transistors, logic gates, and electrical circuits (e.g., application specific integrated (ASIC) circuitry and/or Digital Signal Processor (DSP) circuitry).

In addition, it will be appreciated that the various operations, processes and methods disclosed herein may be embodied in a non-transitory machine-readable medium and/or a machine-accessible medium compatible with a data processing system (e.g., client device 104). Accordingly, the specification and drawings are to be regarded in an illustrative rather than a restrictive sense.

What is claimed is:

1. A method comprising:
determining, through at least one of a decoder engine executing on a processor communicatively coupled to a memory and a hardware decoder, that a reference video frame of one of a bi-predicted frame and a predicted frame currently being decoded is one of: unavailable and corrupt; and
initializing, through the at least one of the decoder engine executing on the processor and the hardware decoder, a previously initialized another reference video frame of the one of the bi-predicted frame and the predicted frame as the reference video frame instead of the one of: the unavailable and the corrupt reference video frame to enable prediction of the one of the bi-predicted frame and the predicted frame with reduced distortion.

2. The method of claim 1, wherein when a backward reference frame for the bi-predicted frame is the one of: the unavailable and the corrupt reference video frame, the initialization comprises:
initializing a forward reference frame thereof in place of the one of: the unavailable and the corrupt backward reference frame as the backward reference frame, the forward reference frame being a video frame in a temporal past compared to the bi-predicted frame, and the backward reference frame being a video frame in a temporal future compared to the bi-predicted frame.

3. The method of claim 1, wherein when the bi-predicted frame requires a plurality of forward reference frames and a plurality of backward reference frames for prediction thereof and at least one forward reference frame and at least one backward reference frame of the plurality of forward reference frames and the plurality of backward reference frames respectively are one of: unavailable and corrupt, the initialization further comprises:
initializing a previously initialized forward reference frame after a key frame as the at least one forward reference frame and the at least one backward reference frame; and
replacing the newly initialized at least one backward reference frame with a second reference video frame upon the second reference video frame being marked as the at least one backward reference frame.

4. The method of claim 1, comprising modifying a pointer to a location of a memory address of the reference video frame to initialize the previously initialized another reference video frame of the one of the bi-predicted frame and the predicted frame as the reference video frame.

5. The method of claim 1, wherein the previously initialized another reference video frame of the one of the bi-predicted frame and the predicted frame is temporally closest to the one of the bi-predicted frame and the predicted frame compared to at least one other previously initialized reference video frame of the one of the bi-predicted frame and the predicted frame.

6. The method of claim 3, wherein the key frame is an intra-frame.

7. The method of claim 1, further comprising:
receiving, at the at least one of the decoder engine executing on the processor and the hardware decoder, encoded video data including data associated with the one of the bi-predicted frame and the predicted frame being decoded, the encoded video data being a video sequence.

8. A data processing device comprising:
a memory; and
a processor communicatively coupled to the memory, the processor being configured to execute instructions to:
determine that a reference video frame of one of a bi-predicted frame and a predicted frame currently being decoded therethrough is one of:
unavailable and corrupt, and
initialize a previously initialized another reference video frame of the one of the bi-predicted frame and the predicted frame as the reference video frame instead of the one of: the unavailable and the corrupt reference video frame to enable prediction of the one of the bi-predicted frame and the predicted frame with reduced distortion.

9. The data processing device of claim 8, wherein when a backward reference frame for the bi-predicted frame is the one of: the unavailable and the corrupt reference video frame, the processor is configured to execute instructions to:
initialize a forward reference frame thereof in place of the one of: the unavailable and the corrupt backward reference frame as the backward reference frame, the forward reference frame being a video frame in a temporal past compared to the bi-predicted frame, and the backward reference frame being a video frame in a temporal future compared to the bi-predicted frame.

10. The data processing device of claim 8, wherein when the bi-predicted frame requires a plurality of forward reference frames and a plurality of backward reference frames for prediction thereof and at least one forward reference frame and at least one backward reference frame of the plurality of forward reference frames and the plurality of backward reference frames respectively are one of: unavailable and corrupt, the processor is further configured to execute instructions to:
initialize a previously initialized forward reference frame after a key frame as the at least one forward reference frame and the at least one backward reference frame, and
replace the newly initialized at least one backward reference frame with a second reference video frame upon the second reference video frame being marked as the at least one backward reference frame.

11. The data processing device of claim 8, wherein the processor is configured to execute instructions to modify a pointer to a location of a memory address of the reference video frame to initialize the previously initialized another reference video frame of the one of the bi-predicted frame and the predicted frame as the reference video frame.

12. The data processing device of claim 8, wherein the previously initialized another reference video frame of the one of the bi-predicted frame and the predicted frame is temporally closest to the one of the bi-predicted frame and the predicted frame compared to at least one other previously initialized reference video frame of the one of the bi-predicted frame and the predicted frame.

13. The data processing device of claim 10, wherein the key frame is an intra-frame.

14. The data processing device of claim 8, wherein the processor is further configured to execute instructions to:
receive encoded video data including data associated with the one of the bi-predicted frame and the predicted frame being decoded, the encoded video data being a video sequence.

15. A system comprising:
a source data processing device configured to encode video data including data associated with one of a bi-predicted frame and a predicted frame as a video sequence; and
a decoder communicatively coupled to the source data processing device, the decoder being at least one of a hardware decoder and a decoder engine executing on a processor communicatively coupled to a memory, and the decoder being configured to:
determine that a reference video frame of the one of the bi-predicted frame and the predicted frame currently being decoded therethrough is one of: unavailable and corrupt, and
initialize a previously initialized another reference video frame of the one of the bi-predicted frame and the predicted frame as the reference video frame instead of the one of: the unavailable and the corrupt reference video frame to enable prediction of the one of the bi-predicted frame and the predicted frame with reduced distortion.

16. The system of claim 15, wherein when a backward reference frame for the bi-predicted frame is the one of: the unavailable and the corrupt reference video frame, the decoder is configured to:
initialize a forward reference frame thereof in place of the one of: the unavailable and the corrupt backward reference frame as the backward reference frame, the forward reference frame being a video frame in a temporal past compared to the bi-predicted frame, and the backward reference frame being a video frame in a temporal future compared to the bi-predicted frame.

17. The system of claim 15, wherein when the bi-predicted frame requires a plurality of forward reference frames and a plurality of backward reference frames for prediction thereof and at least one forward reference frame and at least one backward reference frame of the plurality of forward reference frames and the plurality of backward reference frames respectively are one of: unavailable and corrupt, the decoder is configured to:
initialize a previously initialized forward reference frame after a key frame as the at least one forward reference frame and the at least one backward reference frame, and
replace the newly initialized at least one backward reference frame with a second reference video frame upon the second reference video frame being marked as the at least one backward reference frame.

18. The system of claim 15, wherein the decoder is configured to modify a pointer to a location of a memory address of the reference video frame to initialize the previously initialized another reference video frame of the one of the bi-predicted frame and the predicted frame as the reference video frame.

19. The system of claim 15, wherein the previously initialized another reference video frame of the one of the bi-predicted frame and the predicted frame is temporally closest to the one of the bi-predicted frame and the predicted frame compared to at least one other previously initialized reference video frame of the one of the bi-predicted frame and the predicted frame.

20. The system of claim 17, wherein at least one of:
the processor executing the decoder engine is one of: part of the source data processing device and external to the source data processing device, and
the key frame is an intra-frame.
